(19) United States
(12) Patent Application Publication
(10) Pub. No.: US 2025/0320027 A1
(43) Pub. Date: Oct. 16, 2025

(54) LAMINATED BOARD, PALLET AND METHODS OF LAMINATING A BOARD

(71) Applicant: BASF SE, Ludwigshafen am Rhein (DE)

(72) Inventors: Thomas William MCKAY, Greenville, SC (US); Elias Ruda SHAKOUR, Ann Arbor, MI (US); Jon P Pavlinac, South Lyon, MI (US)

(73) Assignee: BASF SE, Ludwigshafen am Rhein (DE)

(21) Appl. No.: 18/866,657

(22) PCT Filed: May 30, 2023
(86) PCT No.: PCT/US2023/023821

§ 371 Date: Nov. 18, 2024

Related U.S. Application Data
(60) Provisional application No. 63/347,753, filed on Jun. 1, 2022.

(51) Int. Cl. B65D 19/00; B32B 7/12; B32B 21/10; B32B 37/10; B32B 37/12

(52) U.S. Cl. CPC B65D 19/0048; B32B 7/12; B32B 21/10; B32B 37/10; B32B 37/1284; B32B 2260/021; B32B 2260/046; B32B 2262/10; B32B 2439/00; B65D 2519/00029; B65D 2519/00034; B65D 2519/00044; B65D 2519/00064; B65D 2519/00069; B65D 2519/00079; B65D 2519/00099; B65D 2519/00104; B65D 2519/00114; B65D 2519/00273; B65D 2519/00293; B65D 2519/00323; B65D 2519/00333; B65D 2519/00462

(57) ABSTRACT

Disclosed herein are reinforced laminated wooden boards suitable for use in pallets and other constructions, as well as methods for making them. A board disclosed herein includes a wood-based core comprising a front surface, a top surface, a rear surface, and a bottom surface; and a reinforcing material adhered to at least a portion of at least one of the front surface, the top surface, the rear surface, and the bottom surface with a binder composition. Pallets disclosed herein include one or more such boards.

### FIELD

This application relates generally to laminated wood-based boards, uses thereof and methods of making them. In some embodiments, this application relates to pallets incorporating one or more such laminated boards.

### BACKGROUND

Traditionally, wooden pallets have been viewed as disposable, one-time, or limited use products. With increased environmental awareness with respect to wood use as well as manufacturing, shipping, storage, and other costs, reusable pallets have become more desirable. Thus, pallet made completely of plastic or resin materials have entered into the market place because of their perceived increased longevity. Additionally, pallet pooling services have come forward which rent pallets out to clients, which are then returned and repaired if necessary and sent out for reuse. This repair and re-use model is economically and environmentally advantageous. Extending the life of wooden pallets is crucial to the success and profitability of such enterprises.

With repeated use, enhanced performance of a pallet or its component parts is beneficial for extending the life of the pallet. Thus, there is a need for boards, and/or pallets having improved performance characteristics.

### SUMMARY

Disclosed herein are wood-based boards having improved performance for use in various applications, including, but not limited to, use in pallets.

Some embodiments provide a board comprising a wood-based core comprising a front surface, a top surface, a rear surface, and a bottom surface; and a reinforcing material adhered to at least a portion of at least one of the front surface, the top surface, the rear surface, and the bottom surface with a binder composition.

In some embodiments, the binder composition is a polymer composition that binds the reinforcing material to the wood-based core at least partially due to interaction with water in the wood-based core.

In some embodiments the binder composition comprises a polyurea resin composition or a polyurethane resin composition.

In some embodiments the reinforcing material is crushed glass, fibers selected from glass, basalt, natural fibers, synthetic fibers, a fabric reinforced with such materials, or combinations thereof.

In some embodiments the reinforced fabric may be a woven or non-woven fabric.

In some embodiments, the reinforcing material extends to substantially the entire front surface of the wood-based core.

In some embodiments, the reinforcing material extends to at least one additional fork-lift engaging surface

In some embodiments the at least one additional fork-lift engaging surface is at least one of a portion of the bottom-surface, a portion of the top surface.

In some embodiments the reinforcing material extends to and covers substantially the entire front surface and substantially the entire top surface of the wood-based core.

In some embodiments the wood-based core is a board made from natural or composite wood materials.

In some embodiments the reinforcing material extends from and covers the front surface over the top surface to the rear surface.

In some embodiments the reinforcing material covers a portion of each of the front surface, top surface, and rear surface of the wood-based core.

In some embodiments the reinforcing material covers substantially all of each of the front surface, bottom surface, and rear surface of the wood-based core.

In some embodiments substantially all surfaces of the board are covered with the reinforcing material.

Some embodiments provide a pallet comprising at least one board as described above. Some embodiments provide a pallet comprising a first exterior board, wherein the first exterior board is wood-based and defines an externally facing surface, a top surface, an internally facing surface, and a bottom surface, wherein at least at least a portion of the externally facing surface of the wood-based core comprises a reinforcing material adhered thereto; and a plurality of pallet boards aligned such that the externally facing surface of the first exterior board faces externally, away from the plurality of pallet boards.

Some embodiments further provide a second exterior board, wherein the second exterior board is wood-based and defines a second externally facing surface a second top surface, a second internally facing surface, and a second bottom surface wherein at least at least a portion of the externally facing surface of the second exterior board comprises a reinforcing material adhered thereto; and wherein the plurality of pallet boards are arranged between the first exterior board and the second exterior board such that the externally facing surface and the second externally facing surface of the first exterior board and the second exterior board, respectively, faces away from the plurality of pallet boards therebetween.

In some embodiments, each of the plurality of pallet boards further comprise a pallet board top surface and a pallet board bottom surface, wherein at least a portion of one or both of the pallet board top surface and the pallet board bottom surface comprises a polymer based coated adhered thereto.

Some embodiments provide a method of laminating a board, the method comprising providing at least one wood-based core; providing at least one reinforcing material applied to at least a portion of a surface of the at least one wood-based core; spraying a binder composition onto the reinforcing material a pre-laminated board; and compression molding the pre-laminated board such that the reinforcing material and the wood-based core are adhered to one another.

In some embodiments, the binder composition comprises a polyurea resin composition or a polyurethane resin composition.

In some embodiments, the binder composition reacts with one or more compound in the wood-based core to create an intermingled bond between the wood-based core and the reinforcing material.

These and other embodiments will be apparent upon a full reading of the specification without differing from the scope and spirit of this disclosure.

### BRIEF DESCRIPTION OF THE DRAWINGS

Aspects, features, benefits and advantages of the embodiments described herein will be apparent with regard to the following description, appended claims, and accompanying drawings where:

FIG. 1 is an exploded view of an exemplary pallet.

FIG. 2 is a photo showing a laminated board in accordance with some embodiments.

FIG. 3 is a photo showing a laminated board in accordance with some embodiments, depicting cutting effects.

FIG. 4 is a photo showing a laminated board in accordance with some embodiments, depicting cutting effects.

FIG. 5 is a photo showing a laminated board in accordance with some embodiments, depicting physical damage to an end with minimal delamination.

FIG. 6 is a photo showing a laminated board in accordance with some embodiments compared to an unlaminated board, depicting nailing effect.

### DETAILED DESCRIPTION

Lamination of wood is used on pallets to give the appearance of plastic and to extend the useful life of the boards before needing repair and replacement.

Disclosed herein is the production of a laminate of polyurethane or polyurea and a reinforcing material. The reinforcing material may be loose material, dispersed particulate or fibrous material, or a reinforced fabric. In the case of a reinforced fabric, a single or multiple woven and/or non-woven fabrics alone or in combination may be used. The reinforcing material may be any suitable reinforcing material. The material may be loose, such as crushed glass fibers, whole glass fibers, basalt fibers, natural fibers, synthetic fibers, etc. Those fiber may also be in the form of a fabric or sheet and may be woven or non-woven. Multiple layers, sheets or fabrics may be used. A combination of reinforcing materials may be used depending upon the desired properties.

A binder is used to adhere the reinforcing material to the wooden core. The binder used maybe any binder suitable for affixing the reinforcing material to the wooden core. The binder composition may comprise a polyurea resin composition or a polyurethane resin composition. In some embodiments, the binder reacts with compositions in the wood core to intermingle within the wood core which enhances adhesion and reduces flaking or delamination. In some embodiments, the binder reacts with water, cellulose, lignin, or other compounds present in the wood core.

The reinforcing material is applied to a wood-based core, such as, but not limited to a wooden board. Any type or species of wood may be used, including natural wood or composite woods, the construction may be solid or hollow.

In some instances, a spray transfer molding process or liquid compression molding process is used to create the laminate on and around the wood using a mold and heat. The process could also be any compression molded scheme.

The wood core, laminated on the outside with polyurethane and reinforcing material, such as a glass fabric, creates an appearance of plastic while reducing damage from forklifts and other devices during handling of the pallet, ultimately reducing the maintenance required on the pallet and the lifetime of the boards which are laminated.

The board may be laminated on all surfaces or on select surfaces. For example, to save lamination costs, lamination may be limited to high stress areas that make repeated contact with, for example, a forklift, product, or attachment (e.g. nailing) surfaces. The laminated areas may be nailed, screwed, cut or otherwise treated as any other wood surface. For example, one or all of the outer edges of a board may be laminated to afford protection to surfaces exposed to the most damage. In a pallet configuration, the outer edges could be laminated. Similarly, the areas subjected to nailing or screwing to connect boards to underlying structural elements may be laminated. Further, the lower surface of the boards, which endure contact and sliding engagement with forklifts could also be laminated. Similarly, the upper surface could benefit from such lamination-which may also provide a measure of protection from water damage. Of course, an entire board could be laminated on all exterior surfaces to essentially provide a fully laminated board.

Whether to apply lamination to all of a board, or which particular parts of a board or pallet is ultimately a business decision based on many factors, including price and performance combinations.

As mentioned above, the laminated boards disclosed herein are ideally suited to construct shipping pallets. Any type of shipping pallet that can be constructed of wooden boards or blocks can be made using one or more boards or blocks disclosed herein.

As is well known in the art, such pallets typically have horizontally arranged deck boards and stringers arranged vertically under a top layer of deck boards. A bottom deck is optional, and often includes fewer boards than the top deck. The upper deck typically includes a first exterior board and an opposed second exterior board with a plurality of pallet deck boards therebetween. Stringer pallets typically contain a stringer board at either edge and at least one center stringer. The stringers are typically perpendicular to the deck boards to provide support. Sometimes a single center stringer is used; but other times two center stringers will be used, e.g., either touching one another or separated by about 6 to 20 inches to distribute the load evenly. The pallet may be any size, and the number and location of stringers and deck boards is chosen with the size and shape of the pallet in mind, as well as the intended cargo.

Instead of stringers, some pallets comprise blocks and connector boards, to which are nailed top and bottom deck boards. The concepts are similar, with deck boards used to support the cargo, and the blocks and connector boards serving the same function as the stringers—to connect and support the deck boards.

All of the boards may be of various widths, lengths, and thicknesses. Typically, however, deck boards are 1×4 s or 1×6 s. Stringers are typically 2×4 s or 3×4 s. A typical block pallet might contain 6 outer blocks, 3 center blocks, 3 connector boards, 4 top deck boards that are approximately 1×4-×40 inches, 5 top deck boards that are approximately 1×6×40 inches, 3 bottom deck boards that are approximately 1×6×37 inches, and 2 bottom deck boards that are approximately 1×6×40 inches. Again, any combination of materials may be used to achieve the desired size and support characteristics of a particular pallet.

A pallet can be configured as a two-way pallet, wherein the stringers permit the entry of forktines from two opposite directions only. Alternatively, the pallet can be configured as a four-way pallet, wherein the stringers are notched, or otherwise cut, to permit entry of forktines from all four directions.

The deck and bottom boards in a stringer pallet can be flush with the outer edge of the outer stringers, making for a “flush pallet,” or the deck and/or bottom boards can be extended past the outer edge of the outer stringers, making for a “single-wing” or “double-wing” pallet. Also, the bottom boards can be completely omitted, making for a “single-deck” or “skid” pallet.

If desired, the deck and bottom boards can be configured such that their number, size, and placement are the same, top and bottom, making for a “reversible” pallet.

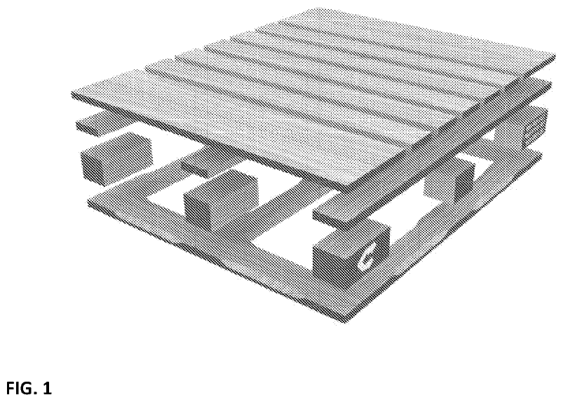

FIG. 1 is an exploded view of an exemplary block and connector wooden pallet. The pallet is made up of a plurality of pallet deck boards, including a first exterior deck board and a plurality of interior deck boards, and typically, a second exterior deck board. The interior deck boards are arranged between the first exterior deck board and the second exterior deck board, and define an upper working surface and a lower surface. The upper working surface is adapted to receive goods to be stored on the pallet, while the lower surface is adapted for engaging the tines of a fork lift for moving the pallet.

It will be appreciated that certain portions of a pallet and the boards that constitute the pallet are subject to more contact with damaging objects such as the goods to be stored, a forklift, or other surfaces such as floors. These areas are most beneficially modified as described herein.

For example, the first and second exterior deck boards are most likely to make contact with the tines or other parts of a forklift and thus, should be the subject of reinforcement. Similarly, all exterior edges of the pallet are subject to similar contact and would benefit from reinforcement. By contrast, interior edges, such as those between deck boards, are less likely to be damaged by a forklift, and thus will benefit less from the enhancements described herein. Similarly, the lower surface of the pallet boards will blindly receive the forklift and could be subject to damage, and thus the lower surfaces are suitable for protection. The upper surfaces of the deck boards will receive the loads and may be subject to scraping and other detrimental actions, and therefore would also benefit from being reinforced. Further, there are several attachment areas on the boards. These attachment areas vary from pallet to pallet but are essentially located anywhere a deck board is affixed to an underlying stringer, block or connector board. The reinforcing materials described herein, among other things, provide for enhanced nailing and screwing such that it is advantageous to include the reinforcing materials described herein at locations where fasteners such as nails and screws may be used to secure a pallet board to another board. The materials described herein are well adapted to allowing removal of both nails and screws, which allows for reuse of the same board. Testing has shown minimal damage from repeated nailing or screwing in areas reinforced in accordance with this disclosure.

Although it is anticipated that the deck boards will benefit most from the reinforcement described herein, any surface or edge of any board, block, stringer or other part of a pallet maybe reinforced as desired.

It is anticipated that even reinforced boards will eventually need to be repaired or replaced. The reinforced boards described herein will increase the life of the pallet by extending the life of boards subject to damage. Unlike plastic pallets, wooden boards can be replaced if damaged, thus, a pallet having reinforced boards will last longer because of the reinforcement, but also because worn or damaged boards can be replaced.

As noted above, many lamination processes are suitable for adhering the reinforcing material to the wood core. Compression molding and spray transfer molding are particularly well-suited to this application. For example, the spray transfer molding technique described in US@@ is particularly well-suited for the application. US@@ is hereby incorporated by reference in its entirety.

Generally, a method of laminating a board, as used herein, comprises providing at least one wood-based core; providing at least one reinforcing material applied to at least a portion of a surface of the at least one wood-based core; spraying a binder composition onto the reinforcing material to yield a pre-laminated board; and compression molding the pre-laminated board such that the reinforcing material and the wood-based core are adhered to one another. The binder maybe activated by moisture or other compounds in the wood-based core, by the compression, or other means such as heat, which may be applied. The activation means depends on the binder used.

Example 1: A sample of wood for pallet use, approximately 18″ in length, was laminated on BASF's spray transfer molding prototype equipment in the Clark St pilot center in Wyandotte, MI.
Binder:
Reinforcing material:
Wood type: 1×3, 1×4

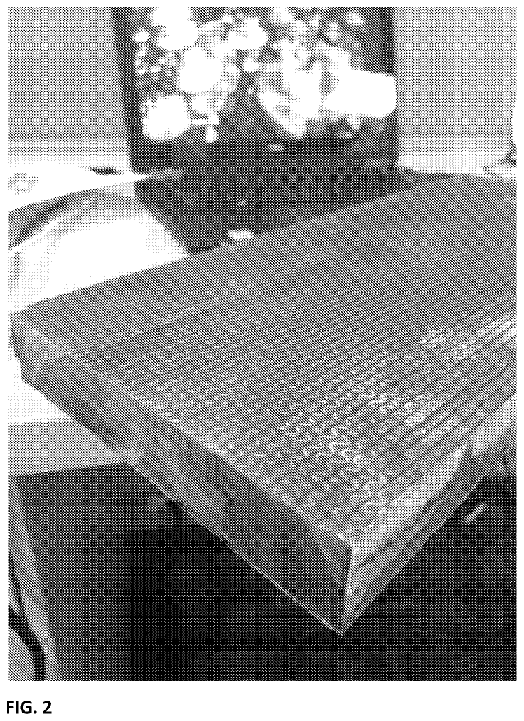

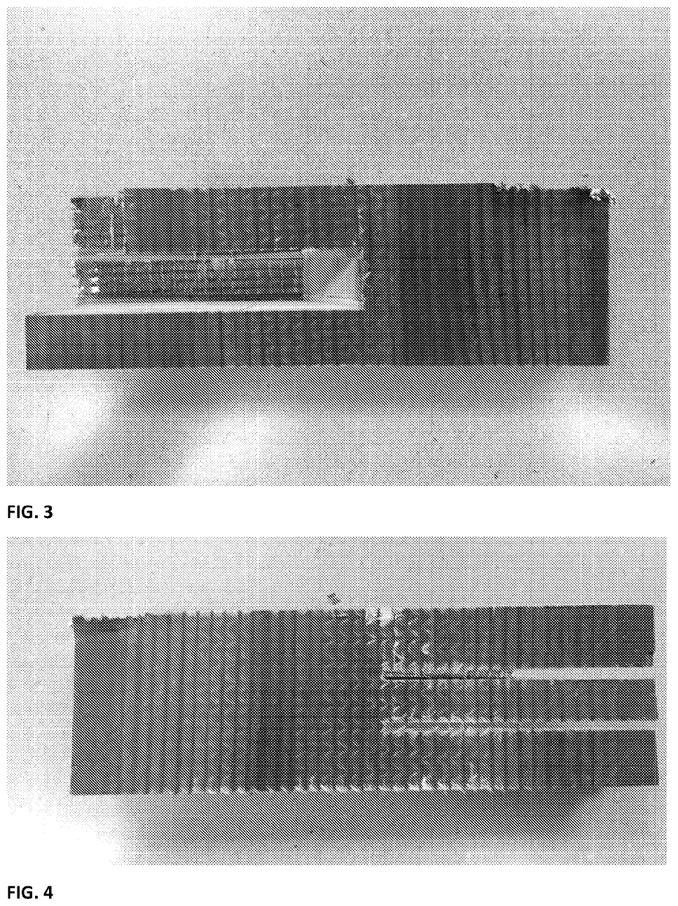

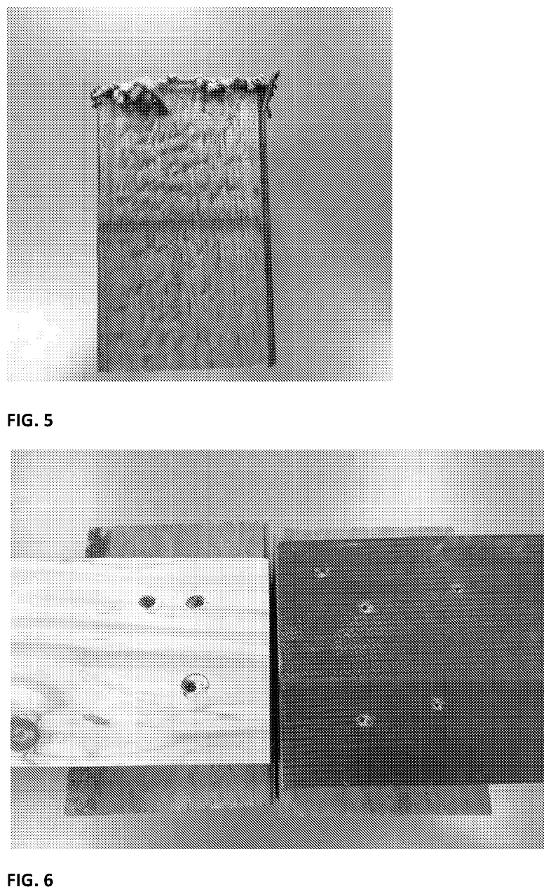

This sample was sent to a pallet pooling service to gauge interest and performance. FIGS. 2-6 demonstrate the laminated board can be cut, hammered and with minimal delamination or undesirable breakdown of the materials. The laminate appeared to enhance the holding power of a nail even after removal and driving another nail through the laminate. This was not put in use, and was prepared solely to demonstrate typical properties of the laminated wood as described herein.

### Example 2: a Sample of Wood for Pallet Use, was Laminated with the Following Characteristics

Wood: 5.4: ×0.74″ (nominal)
Reinforcing material: [0/90] Owens Corning Glass Fiber, areal density of 300 g/m²
Binder: Polyurethane with areal density applied at a rate of 450 grams/m2

These samples were subjected to flexural strength and breakages tests and performed better than unlaminated boards with minimal delamination.

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

As used herein, the term “about” means plus or minus 10% of the numerical value of the number with which it is being used. Therefore, about 50 g means in the range of 45 g-55 g.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also understood that this disclosure is not limited to particular compositions, methods, apparatus, and articles, as these may vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A board comprising:
a wood-based core comprising a front surface, a top surface, a rear surface, and a bottom surface; and
a reinforcing material adhered to at least a portion of at least one of the front surface, the top surface, the rear surface, and the bottom surface with a binder composition.

2. The board of claim 1, wherein the binder composition is a polymer composition that binds the reinforcing material to the wood-based core at least partially due to interaction with water in the wood-based core.

3. The board of claim 2, wherein the binder composition comprises a polyurea resin composition or a polyurethane resin composition.

4. The board of claim 2, wherein the reinforcing material is crushed glass, fibers selected from glass, basalt, natural fibers, synthetic fibers, a fabric reinforced with such materials, or combinations thereof.

5. The board of claim 4, wherein the reinforcing material may be a woven or non-woven fabric.

6. The board of claim 1, wherein the reinforcing material extends to substantially the entire front surface of the wood-based core.

7. The board of claim 1, wherein the reinforcing material extends to at least one additional fork-lift engaging surface.

8. The board of claim 7, wherein the at least one additional fork-lift engaging surface is at least one of a portion of the bottom-surface, a portion of the top surface.

9. The board of claim 1, wherein the reinforcing material extends to and covers substantially the entire front surface and substantially the entire top surface of the wood-based core.

10. The board of claim 1, wherein the wood-based core is a board made from natural or composite wood materials.

11. The board of claim 1, wherein the reinforcing material extends from and covers the front surface over the top surface to the rear surface.

12. The board of claim 11, wherein the reinforcing material covers a portion of each of the front surface, top surface, and rear surface of the wood-based core.

13. The board of claim 11, wherein the reinforcing material covers substantially all of each of the front surface, bottom surface, and rear surface of the wood-based core.

14. The board of claim 1, wherein substantially all surfaces of the board are covered with the reinforcing material.

15. A pallet comprising:
a. a first exterior deck board, wherein the first exterior deck board is wood-based and defines an externally facing surface, a top surface, an internally facing surface, and a bottom surface, wherein at least at least a portion of the externally facing surface of the first exterior deck board comprises a reinforcing material adhered thereto; and
b. a plurality of pallet deck boards aligned such that the externally facing surface of the first deck exterior board faces externally, away from the plurality of pallet deck boards.

16. The pallet of claim 15, further comprising a second exterior deck board, wherein the second exterior deck board is wood-based and defines a second externally facing surface a second top surface, a second internally facing surface, and a second bottom surface wherein at least at least a portion of the externally facing surface of the second exterior deck board comprises a reinforcing material adhered thereto; and
wherein the plurality of pallet deck boards are arranged between the first exterior deck board and the second exterior deck board such that the externally facing surface and the second externally facing surface of the first exterior deck board and the second exterior deck board, respectively, faces away from the plurality of pallet deck boards therebetween.

17. The pallet of claim 15, wherein each of the plurality of pallet deck boards further comprise a pallet board top surface and a pallet board bottom surface, wherein at least a portion of one or both of the pallet board top surface and the pallet board bottom surface comprises a polymer based coated adhered thereto.

18. A method of laminating a board, the method comprising:
providing at least one wood-based core;
providing at least one reinforcing material applied to at least a portion of a surface of the at least one wood-based core;
spraying a binder composition onto the reinforcing material a pre-laminated board; and
compression molding the pre-laminated board such that the reinforcing material and the wood-based core are adhered to one another.

19. The method of claim 18, wherein the binder composition comprises a polyurea resin composition or a polyurethane resin composition.

20. The method of claim 18, wherein the binder composition reacts with one or more compound in the wood-based core to create an intermingled bond between the wood-based core and the reinforcing material.
